(19) United States
(12) Patent Application Publication
(10) Pub. No.: US 2009/0143049 A1
(43) Pub. Date: Jun. 4, 2009

(54) MOBILE TELEPHONE HUGS INCLUDING CONVEYED MESSAGES

(75) Inventors: Liang Chen, Beijing (CN); Rebecca J. Sundling, Beijing (CN); Wei Hun Liew, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/949,771

(22) Filed: Dec. 4, 2007

(51) Int. Cl. H04Q 7/22; H04Q 7/20

(52) U.S. Cl. 455/412.2; 455/466

(57) ABSTRACT

Described is a technology by which a mobile telephone sends and/or receives and outputs a “mobile hug” comprising a personalized special message. A mobile hug output comprises vibration rhythms (patterns) and/or other sound and/or image data that identifies a source of the incoming information, and/or may convey a personal message. A mobile hug protocol is exemplified in which a vibration timeline, a sound timeline, and/or an image timeline each comprising units from which a sender can assemble a “sentence” to convey the special message.

### BACKGROUND

Mobile telephones are no longer simply communication devices. For example, in addition to placing and receiving telephone calls, mobile telephones can provide some computing functionality, obtain and output media files (e.g., photographs, music, or video), and perform other operations such as providing email and internet access.

Mobile telephones are thus becoming more like hybrids of communication, computing and other electronic devices. However, mobile telephones with such computing functionality are generally designed like business-centric computers, with the central focus being to provide access to computer programs. This is true even though many mobile telephone users primarily use their telephones for personal communication based on personal relationships.

While some mobile telephones provide for personalized ringtones that can inform a receiving party as to who is calling without having to look at the device, mobile telephones are not very personal in nature. Moreover, a personalized ringtone is of no use when the mobile telephone is set to a vibration (e.g., meeting or silent profile) mode.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which mobile telephones are configured with an option for receiving and/or sending a special, personal type of message (referred to herein as a “mobile hug”) that may identify the caller regardless of vibrate or ring mode.

In one aspect, a mobile hug may comprise a vibration set of at least one vibration rhythm (pattern) that when output on a receiving device identifies a specific source of the incoming information relative to other possible sources. Audible and/or visible information may also be output in association with the vibration set.

The mobile hug output may convey information corresponding to a predefined type of message, e.g., from a default set or from a customized, personalized message. The conveyed information is defined in that it is understandable by the recipient, even if only felt rather than heard or viewed.

In one example implementation, the mobile hug is received as a set of at least one timeline, including a vibration timeline, a sound timeline, and/or an image timeline. A protocol/data structure provides the format. Each timeline in the set comprises one or more units, that each identifies data already maintained on the recipient mobile communications device. In this manner, a sender can assemble a “sentence” of units to convey a customized message output.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components of a mobile telephone configured to operate to receive and/or send a very personal message (“a mobile hug”).

FIG. 2 is a block diagram representing an example data format that may be used to send and/or process a mobile hug.

FIG. 3 is a flow diagram representing example steps taken to output the mobile hug when received by the recipient.

FIG. 4 shows an illustrative example of a computing and communication device into which various aspects of the present invention may be incorporated.

### DETAILED DESCRIPTION

Various aspects of the technology described herein are generally directed towards mobile telephones that send and/or receive and process personal messages (referred to herein as “mobile hugs”). In general, this provides for special messaging between related telephone users, including at times when a recipient can only feel a vibration pattern.

As will be understood, various examples set forth herein are primarily described with respect to a relationship between two or three mobile telephones, however it is understood that any practical number of mobile telephones or like communication-capable devices may operate, share information and/or output information in the manner described herein. Further, while the concept of a related “person” or individual persons is generally described herein, it can be readily appreciated that it is feasible to have special relationships with a “group” of more than one person. For example, a mother may send a special personal message (a mobile hug as described herein) to a group comprising her children; the mobile telephone may then send out a series of such messages to each member in the group, for example.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in mobile devices and communication in general.

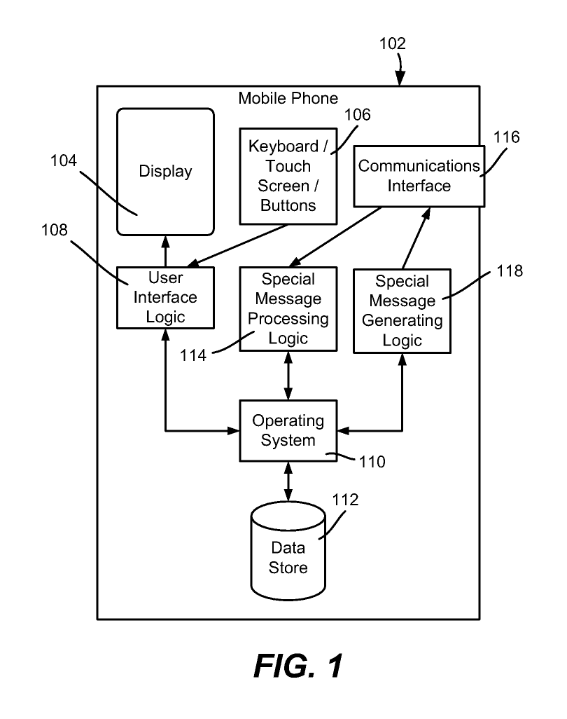

Turning to FIG. 1, there is shown a mobile telephone 102 that is capable of sending and receiving/processing a mobile hug. In general, the user interacts with the device based on the output of the current display 104 via a keyboard, touch screen and/or other buttons 106. User interface logic 108 which may be part of the operating system 110 or associated with the operating system 110 provides a way to couple user input interaction with the display output and other actions, based on various data in a data store 112 maintained on the device. For example, as described below, the data store 112 may maintain data (e.g., modules or like data units) for generating a mobile hug to send, and/or for outputting tactile, audible and/or visible feedback comprising a mobile hug output.

In general, with a mobile hug, certain communications can be specially handled and result in a recipient mobile device operating differently with respect to its output. Mobile hugs (which generically refer to what are intended to be very personal greetings) on a mobile device operate by providing different vibration patterns, possibly in combination with other output elements, to identify a sender, and/or possibly while also conveying a special message. For example, by a combination of varied vibrations (that is, rhythms/patterns) and possibly other output, not only is the sender identifiable without the recipient viewing the device display 104, but a simple emotional message such as “I miss you” or “I am giving you a hug,” possibly along with the mood of the sender, may be communicated. Note that the recipient device needs to be able to generate the output, but the hug may be sent from any device, even a device such as a conventional telephone or personal computer that cannot itself output such a hug, but can instead send one via a web service or communication provider, for example.

In general, conventional mobile telephones have no way for users to determine the source of incoming content for calls and SMS. Although some current mobile telephones use a ringtone as a primary notification method for an incoming call, and users can set different ringtones for different persons to help distinguish who has made a call or sent a text message, there are many circumstances where ringtones are unacceptable. For example, when a ring is a likely distraction, users enter their phones into a “meeting” profile, a silent state or the like where a vibration is used instead of a ringtone to notify the user of any new incoming information. Further, even when ringing is active, a personalized ringtone does not convey any additional information beyond the identity of who is calling/messaging.

In contrast, a mobile hug provides a way for people to communicate subtle emotional messages via a mobile telephone, by combining a variation of vibrations (e.g., variable by rhythms, lengths, intensities, number and/or frequencies) and other simple output elements such as text, graphics, audio and/or colors. This effectively creates a new shared language between people, as a new form of communication that is different from a voice call or SMS, (although voice or SMS may provide the underlying means for sending the message).

To this end, in one example implementation, an SMS message or the like (e.g., MMS) may have codes (e.g., binary data) embedded therein that do not directly correspond to conventional ASCII or Unicode text. Special message processing logic 114 (FIG. 1) detects such codes when received in a message or the like over a communications interface 116, and operates the mobile telephone device 102 differently when detected. Filtering may be implemented, such that only a certain sender (or senders) is allowed to cause a mobile hug on a particular recipient's device, that is, a mobile telephone may be configured to only accept mobile hugs from a specific caller or limited set of callers; other callers only may be able to send conventional text messages, for example.

As described above, if an allowed sender sends a special message to a recipient, the mobile phone may vibrate, put up special text, glow a certain color, and/or provide other visible, tactile and/or audible output to let the receiver know that a special, very personal message (i.e., a hug) has been sent, as well as who has sent it. The person who receives the “hug” feels the message through the pattern of vibrations and any other elements.

Different types of hugs may be sent, including a customized hug and a hug looked up from within a maintained library of hugs, e.g., in the data store 112 of FIG. 1. To this end, hugs can be chosen from a predefined list, or users can create their own meanings through a combination of elements. For example, some number (such as ten) different vibration variations, different audio sounds, and an assortment of images may be made available for a person to create a new “sentence” that is sent to the other mobile telephone.

By way of example, as represented by the special messaging generating logic 118, a sender may choose a vibration set, audio sound set and/or image set that already exists, or may construct a new mobile hug. Various modules or the like each representing a vibration, audible sound and/or text/graphics/image may assembled into a customized message that the recipient will typically recognize (or learn to recognize, such as from accompanying text or an out-of-band communication). For example, for a pair of users, a short-long-short vibration set may identify the sender and also convey “I miss you,” while a long vibration followed by a short vibration may mean “call me.” For a different pair of users, those same patterns may have entirely different meanings (assuming those patterns are not predefined by default and unchangeable in a given device).

Returning to the aspects related to receiving a processing a mobile hug, once the code is understood and output at the recipient device, recognition of the meaning occurs. The output may be instantaneous, or some or all of the output may depend on the current state of the receiving telephone. By way of example, if a receiving telephone is in a normal operating mode, the full hug message possibly including audio may be played. However, if in a meeting mode, only the vibration and video may play; the full hug message including audio may be stored for complete output at a later time.

Further, a receiving telephone may defer some or all of the hug playback until there is some indication that the recipient has the telephone available. A power-on state, proximity detection, interaction sensing and so forth may be employed to determine whether a receiving telephone is to output a mobile hug, and if so, how the mobile hug output is to occur and/or be deferred to any extent.

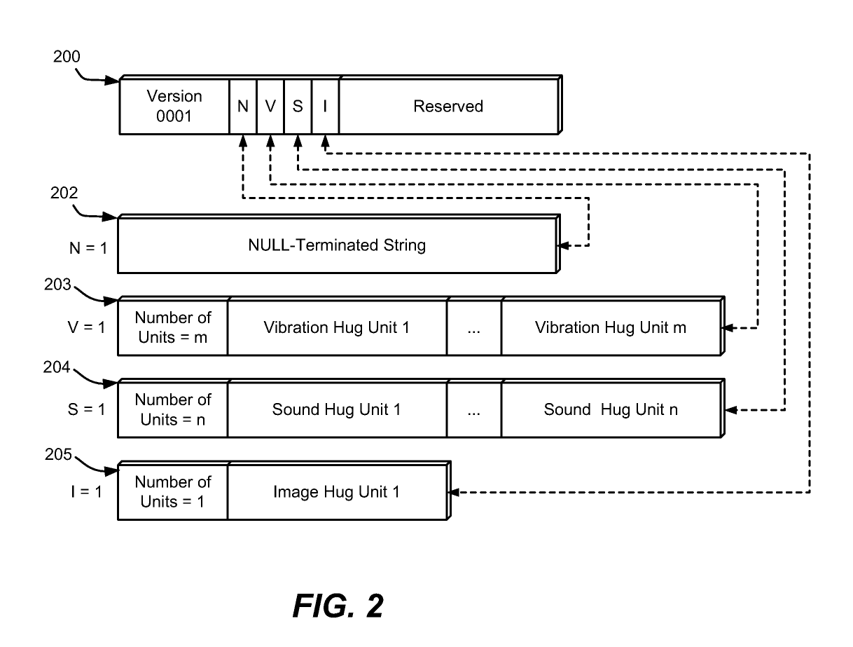

As generally represented in FIG. 2, in one example implementation, an XML protocol format for sending and generating a hug may include three timelines comprising hug units, namely a vibration timeline, a sound timeline and an image timeline. Any combination of timelines is allowed, but there needs to be at least one timeline, that is, an empty hug is not allowed in this example implementation. Note that in this particular example, the vibration timeline and sound timeline allow for multiple hug units, however the image timeline only allows one unit. An image unit may refer to an image, but also may generate any visible output, including text, graphics, animations and/or video playback.

Each hug may have a name with a pre-defined maximum length (e.g., thirty characters), which may be placed in the data structure region 202 of FIG. 2. If the hug received has the same name as a hug that exists in a hug library, the new hug will be played but not stored. An anonymous (nameless) hug is also only played. However as can be readily appreciated, alternative configurations may allow a user to name and/or rename a hug for storage.

As shown in FIG. 2 is a header data structure region 200, in which the most significant four bits represent the version number, e.g., currently one (0001), so that future formats may be developed and recognized via their version number. The next “N” bit indicates whether a name for the hug exists; if so, the bit is set to one (1), and the name is present in a null-terminated string in region 202.

Also in the header, the bits labeled “V” “S” and “I” are indicators of the existence of their corresponding timelines. If the “V” bit is set to one, it indicates that there is a vibration timeline, with the “S” bit similarly indicating whether there is a sound timeline and the “I” bit indicating whether there is an image timeline. The remainder of the structure region 200 is reserved for future usage.

As described above, the timelines (represented by data structure regions 203-205 in FIG. 2) comprise a number that specifies how many hug units are in the timeline, followed by the hug units. In this example version, each hug unit has a unique (at least to the devices) 16-bit number, with the two most significant bits equal to zero (00). Note that in this example protocol, the message is used to deliver identifiers of the hug units that correspond to saved content and data on the recipient device, rather the carrying the actual content and data of the hug units. Thus, each timeline has two parts in this version of the format, namely a 16-bit number of units followed by a corresponding number of 16-bit units.

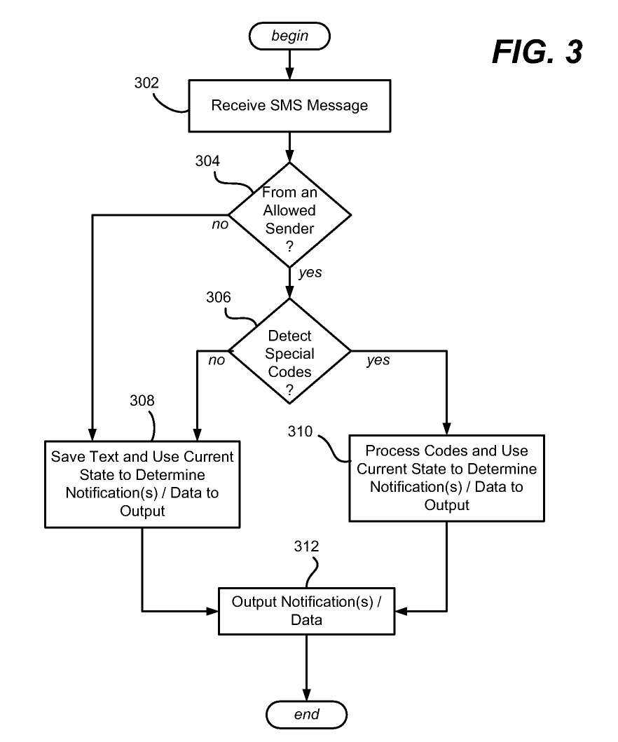

FIG. 3 summarizes an example operation of how a mobile hug-enabled mobile telephone handles a message when received, such as via an SMS message (step 302). Step 304 evaluates whether the message is from a special sender, e.g., someone the recipient user has identified as being allowed to send a mobile hug. If not, step 304 branches to step 308 where the message is treated as any other text message, e.g., the text is saved for later reading, and an appropriate notification is output (e.g., a buzz or ring) at step 312 depending on the current state. Note that step 304 is optional, as a mobile telephone can be configured to receive a hug from any sender.

Step 306 represents the determination of whether the message contains the special hug codes, such as according to the above-described format. If not, step 308 is executed as described above, e.g., the message is treated as a conventional text message.

If the message is recognized as corresponding to a hug, step 306 instead branches to step 310 where the codes are processed to generate a hug or to lookup an existing one. The current state of the device is then used to determine an appropriate output, e.g., audio is not played during an in-meeting state, but may be (depending on the hug units) if in a ring-allowed state.

### Exemplary Operating Environment

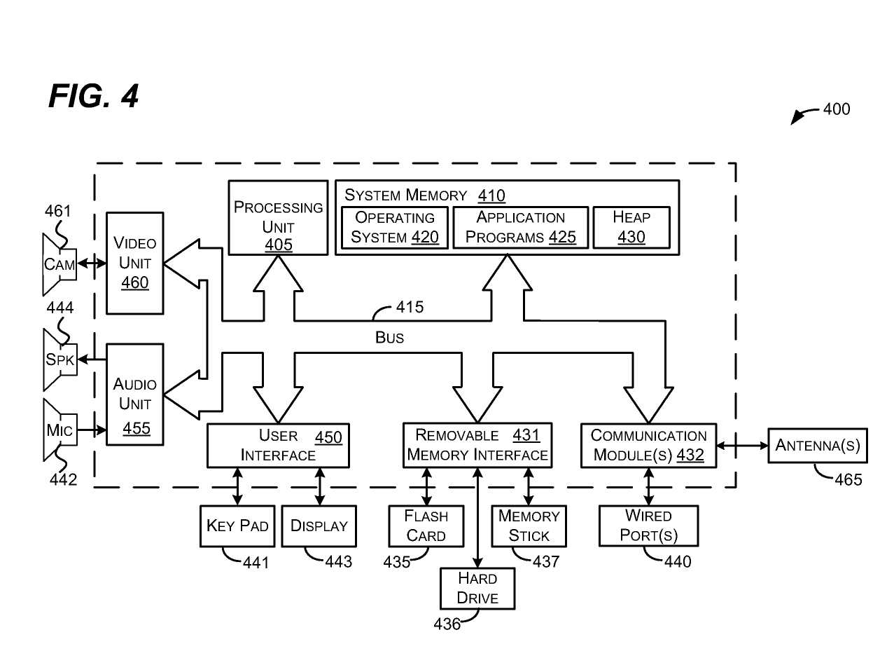

FIG. 4 illustrates an example of a suitable mobile device 400 on which aspects of the subject matter described herein may be implemented. The mobile device 400 is only one example of a device and is not intended to suggest any limitation as to the scope of use or functionality of aspects of the subject matter described herein. Neither should the mobile device 400 be interpreted as having any dependency or requirement relating to any one or combination of components illustrated in the exemplary mobile device 400.

With reference to FIG. 4, an exemplary device for implementing aspects of the subject matter described herein includes a mobile device 400. In some embodiments, the mobile device 400 comprises a cell phone, a handheld device that allows voice communications with others, some other voice communications device, or the like. In these embodiments, the mobile device 400 may be equipped with a camera for taking pictures, although this may not be required in other embodiments. In other embodiments, the mobile device 400 comprises a personal digital assistant (PDA), hand-held gaming device, notebook computer, printer, appliance including a set-top, media center, or other appliance, other mobile devices, or the like. In yet other embodiments, the mobile device 400 may comprise devices that are generally considered non-mobile such as personal computers, servers, or the like.

Components of the mobile device 400 may include, but are not limited to, a processing unit 405, system memory 410, and a bus 415 that couples various system components including the system memory 410 to the processing unit 405. The bus 415 may include any of several types of bus structures including a memory bus, memory controller, a peripheral bus, and a local bus using any of a variety of bus architectures, and the like. The bus 415 allows data to be transmitted between various components of the mobile device 400.

The mobile device 400 may include a variety of computer-readable media. Computer-readable media can be any available media that can be accessed by the mobile device 400 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 400.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, Wi-Fi, WiMAX, and other wireless media. Combinations of any of the above should also be included within the scope of computer-readable media.

The system memory 410 includes computer storage media in the form of volatile and/or nonvolatile memory and may include read only memory (ROM) and random access memory (RAM). On a mobile device such as a cell phone, operating system code 420 is sometimes included in ROM although, in other embodiments, this is not required. Similarly, application programs 425 are often placed in RAM although again, in other embodiments, application programs may be placed in ROM or in other computer-readable memory. The heap 430 provides memory for state associated with the operating system 420 and the application programs 425. For example, the operating system 420 and application programs 425 may store variables and data structures in the heap 430 during their operations.

The mobile device 400 may also include other removable/non-removable, volatile/nonvolatile memory. By way of example, FIG. 4 illustrates a flash card 435, a hard disk drive 436, and a memory stick 437. The hard disk drive 436 may be miniaturized to fit in a memory slot, for example. The mobile device 400 may interface with these types of non-volatile removable memory via a removable memory interface 431, or may be connected via a universal serial bus (USB), IEEE 4394, one or more of the wired port(s) 440, or antenna(s) 465. One of the antennas 465 may receive GPS data. In these embodiments, the removable memory devices 435-137 may interface with the mobile device via the communications module(s) 432. In some embodiments, not all of these types of memory may be included on a single mobile device. In other embodiments, one or more of these and other types of removable memory may be included on a single mobile device.

In some embodiments, the hard disk drive 436 may be connected in such a way as to be more permanently attached to the mobile device 400. For example, the hard disk drive 436 may be connected to an interface such as parallel advanced technology attachment (PATA), serial advanced technology attachment (SATA) or otherwise, which may be connected to the bus 415. In such embodiments, removing the hard drive may involve removing a cover of the mobile device 400 and removing screws or other fasteners that connect the hard drive 436 to support structures within the mobile device 400.

The removable memory devices 435-437 and their associated computer storage media, discussed above and illustrated in FIG. 4, provide storage of computer-readable instructions, program modules, data structures, and other data for the mobile device 400. For example, the removable memory device or devices 435-437 may store images taken by the mobile device 400, voice recordings, contact information, programs, data for the programs and so forth.

A user may enter commands and information into the mobile device 400 through input devices such as a key pad 441 and the microphone 442. In some embodiments, the display 443 may be touch-sensitive screen and may allow a user to enter commands and information thereon. The key pad 441 and display 443 may be connected to the processing unit 405 through a user input interface 450 that is coupled to the bus 415, but may also be connected by other interface and bus structures, such as the communications module(s) 432 and wired port(s) 440.

A user may communicate with other users via speaking into the microphone 442 and via text messages that are entered on the key pad 441 or a touch sensitive display 443, for example. The audio unit 455 may provide electrical signals to drive the speaker 444 as well as receive and digitize audio signals received from the microphone 442.

The mobile device 400 may include a video unit 460 that provides signals to drive a camera 461. The video unit 460 may also receive images obtained by the camera 461 and provide these images to the processing unit 405 and/or memory included on the mobile device 400. The images obtained by the camera 461 may comprise video, one or more images that do not form a video, or some combination thereof.

The communication module(s) 432 may provide signals to and receive signals from one or more antenna(s) 465. One of the antenna(s) 465 may transmit and receive messages for a cell phone network. Another antenna may transmit and receive Bluetooth® messages. Yet another antenna (or a shared antenna) may transmit and receive network messages via a wireless Ethernet network standard.

In some embodiments, a single antenna may be used to transmit and/or receive messages for more than one type of network. For example, a single antenna may transmit and receive voice and packet messages.

When operated in a networked environment, the mobile device 400 may connect to one or more remote devices. The remote devices may include a personal computer, a server, a router, a network PC, a cell phone, a peer device or other common network node, and typically includes many or all of the elements described above relative to the mobile device 400.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a mobile communications device, a method comprising, detecting that an incoming communication is directed towards a mobile hug, and outputting a mobile hug output on the device, the mobile hug output comprising a vibration set of at least one vibration rhythm, or audible information, or visible information, or any combination of a vibration set, audible information and visible information, the mobile hug output identifying a specific source of incoming information relative to other possible sources, and conveying information corresponding to a predefined type of message.

2. The method of claim 1 further comprising, receiving the mobile hug as a set of at least one timeline, including a vibration timeline, a sound timeline, or an image timeline, or any combination of a vibration timeline, a sound timeline, or an image timeline.

3. The method of claim 2 wherein each timeline in the set comprises one or more units, each unit identifying data maintained on the mobile communications device, and further comprising, accessing the data based on each unit to generate the mobile hug output.

4. The method of claim 3 wherein the mobile hug is received as special data within a text message, and further comprising, processing the special data into the mobile hug output.

5. The method of claim 1 wherein the received mobile hug comprises a set of data maintained in a library, and wherein outputting the mobile hug output comprises accessing the library.

6. The method of claim 1 wherein the received mobile hug comprises a named set of data, and further comprising, storing the mobile hug in the library.

7. The method of claim 1 further comprising, determining that the mobile hug is from an allowed sender.

8. In a mobile communications device, a method comprising, detecting that an incoming communication is directed towards a mobile hug, and outputting a mobile hug output on the device comprising a vibration set of at least one vibration rhythm that identifies a specific source of incoming information relative to other possible sources.

9. The method of claim 8 wherein outputting the mobile hug output further comprises conveying information corresponding to a predefined type of message.

10. The method of claim 8 wherein outputting the mobile hug output further comprises outputting audible or visible information, or both audible and visible information, in association with the vibration set.

11. The method of claim 8 wherein the mobile hug is received as a set of at least one timeline, including a vibration timeline, a sound timeline, or an image timeline, or any combination of a vibration timeline, a sound timeline, or an image timeline.

12. The method of claim 11 wherein each timeline in the set comprises one or more units, each unit identifying data maintained on the mobile communications device.

13. The method of claim 8 wherein the mobile hug is received as special data within a text message, and further comprising, processing the special data into the mobile hug output.

14. The method of claim 8 wherein the received mobile hug comprises a set of data maintained in a library, and wherein outputting the mobile hug output comprises accessing the library.

15. The method of claim 8 wherein the received mobile hug comprises a named set of data, and further comprising, storing the mobile hug in the library.

16. In a mobile communications environment, a system comprising:
a database containing data corresponding to mobile hug output data; and
mobile hug processing logic coupled to the database, the mobile hug processing unit detecting codes within a received communication and accessing the database based on the codes to generate a mobile hug output, the mobile hug output comprising a vibration set of at least one vibration pattern, or audible information, or visible information, or any combination of a vibration set, audible information and visible information, the mobile hug output conveying information corresponding to a defined message.

17. The system of claim 16 further comprising means for determining whether the mobile hug is from an allowed sender.

18. The system of claim 16 further comprising means for determining whether the mobile hug is from an allowed sender.

19. The system of claim 16 wherein the codes are formatted according to a protocol that provides for a set of at least one timeline, including a vibration timeline, a sound timeline, or an image timeline, or any combination of a vibration timeline, a sound timeline, or an image timeline, wherein each timeline in the set comprises one or more units, each unit identifying data maintained in the database.

20. The system of claim 16 wherein the protocol includes means for naming a mobile hug for persisting in the database.
